(19) United States
(12) Patent Application Publication
(10) Pub. No.: US 2022/0157552 A1
(43) Pub. Date: May 19, 2022

(54) X-RAY TUBE FOR ANALYSIS

(71) Applicant: CANON ELECTRON TUBES & DEVICES CO., LTD., Otawara-shi (JP)

(72) Inventors: Tatsumitsu OZAWA, Otawara (JP); Takashi SHIMONO, Nasushiobara (JP)

(73) Assignee: CANON ELECTRON TUBES & DEVICES CO., LTD., Otawara-shi (JP)

(21) Appl. No.: 17/586,983

(22) Filed: Jan. 28, 2022

Related U.S. Application Data
(63) Continuation of application No. PCT/JP2019/050953, filed on Dec. 25, 2019.

(30) Foreign Application Priority Data
Aug. 5, 2019 (JP) 2019-143781

(51) Int. Cl. H01J 35/08; H01J 35/14

(52) U.S. Cl. CPC H01J 35/112; H01J 35/147

(57) ABSTRACT

According to one embodiment, an analytical X-ray tube includes a vacuum enclosure with an output window to transmit X-rays, an anode target provided in the vacuum enclosure and opposing the output window, an anode support that supports the anode target. The anode support includes a distal end portion an outer diameter of which is smaller than an outer diameter of the anode target, and a rear side portion on a rear side of the distal end portion, an outer diameter of which is greater than the outer diameter of the anode target, and an outer surface of the rear portion is coated with a coating layer of a same material as that of the anode target.

### CROSS-REFERENCE TO RELATED APPLICATIONS

This application is a Continuation Application of PCT Application No. PCT/JP2019/050953, filed Dec. 25, 2019 and based upon and claiming the benefit of priority from Japanese Patent Application No. 2019-143781, filed Aug. 5, 2019, the entire contents of all of which are incorporated herein by reference.

### FIELD

Embodiments described herein relate generally to an X-ray tube for analysis.

### BACKGROUND

Generally, in analytical X-ray tubes, electrons emitted by a cathode filament are converged by a converging electrode and made to collide with an anode target to generate X-rays.

The generated X-rays are output through an output window of the vacuum enclosure and used as X-rays for analysis.

In the anode target, when electrons collide therewith, X-rays are generated and at the same time, secondary electrons are generated. These secondary electrons may collide with the anode support that supports the anode target and excite impure radiation.

The impure radiation may inappropriately degrade the analytic accuracy.

One of embodiments described herein aims to provide an X-ray tube for analysis, having an improved analytic accuracy.

### BRIEF DESCRIPTION OF THE DRAWINGS

FIG. 1 is a cross-sectional view showing a brief configuration of an analytical X-ray tube according to one embodiment.

FIG. 2 is an enlarged cross-sectional view of an anode target and an anode support shown in FIG. 1.

### DETAILED DESCRIPTION

In general, according to one embodiment, an analytical X-ray tube comprises a vacuum enclosure comprising an output window formed therein to transmit X-rays, a disc-shaped anode target provided in the vacuum enclosure so as to oppose the output window, an anode support that supports the anode target by attaching a tip end thereto, a converging electrode provided on an outer circumference of the anode target and a cathode filament provided on an outer circumference of the converging electrode and emitting electrons to be irradiated on to the anode target, and the anode support includes a distal end portion an outer diameter of which is smaller than an outer diameter of the anode target, and a rear side portion on a rear side of the distal end portion, an outer diameter of which is greater than the outer diameter of the anode target, and an outer surface of the rear portion is coated with a coating layer of a same material as that of the anode target.

The analytic X-ray tube of one embodiment will be described below with reference to the accompanying drawings. Note that in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

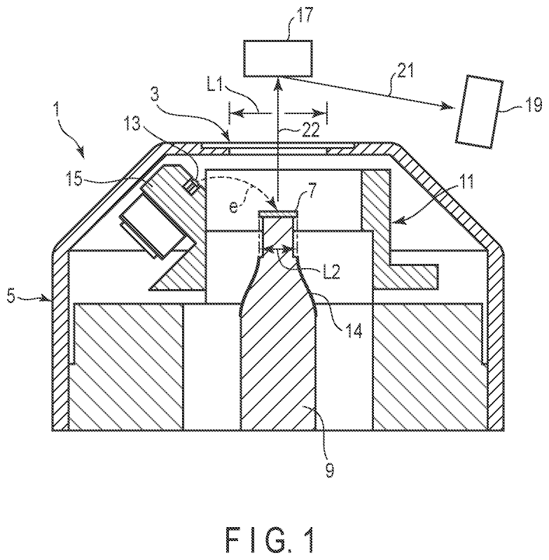

As shown in FIG. 1, an analytical X-ray tube 1 comprises a vacuum enclosure 5 which includes an output window 3 that transmits X-rays formed therein, and inside the vacuum enclosure 5, an anode target 7, an anode support 9, a converging electrode 11 and a cathode filament 13 are provided.

The vacuum enclosure 5 includes a distal end portion whose outer diameter gradually narrows down, and a tip end thereof is a flat surface. The output window 3 described above is provided on the flat surface.

The output window 3 is formed of a material with low X-ray attenuation, for example, beryllium (Be), and is made thin with a thickness of several tens to several hundred micrometers. The diameter of the output window 3 is represented by L1.

The anode target 7 is provided at a tip end of the anode support 9 so as to oppose the output window 3 and is supported by the anode support 9.

The anode target 7 is formed into a disk shape with an outer diameter of L2, and is formed of a materials such as rhodium (Rh) or tungsten (W).

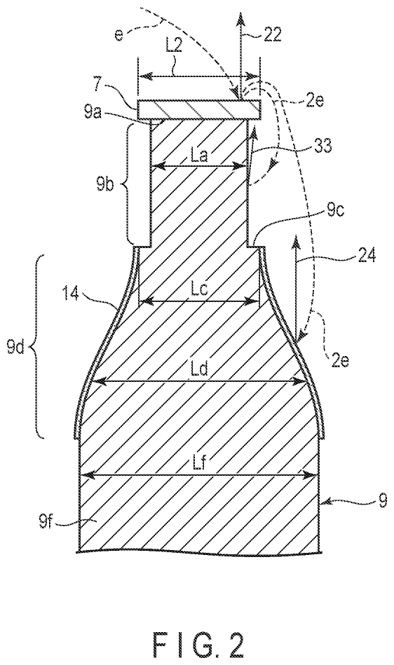

As shown in FIG. 2, the anode support 9 is formed so as to narrow down towards its tip end and is formed of copper (Cu).

The anode support 9 comprises a distal end portion 9b formed to have the same outer diameter as the outer diameter La of the tip end 9a, a step portion 9c situated in a rear side of the distal end portion 9b (on a side away from the output window 3), which has an outer diameter Lc larger than the diameter La, a shoulder portion 9d with an outer diameter Ld that gradually increases from the step portion 9c, and a proximal portion 9f situated on a rear side of the shoulder portion 9d, which has the largest outer diameter Lf.

In this embodiment, the outer diameter Lc of the step portion 9c is the same in dimension as the outer diameter L2 of the anode target.

On the shoulder portion 9d of the anode support 9, a coating layer 14 is formed by coating it with a metal of the same material as that of the anode target 7. For example, when the anode target 7 is of rhodium (Rh), the coating layer 14 is formed by the same metal, Rh, whereas when the anode target 7 is of tungsten (W), the same material, W is used for the coating.

As shown in FIG. 1, the converging electrode 11 is disposed around the outer circumference of the anode target 7, and the cathode filament 13 is disposed on an outer circumferential side of the converging electrode 11. The cathode filament 13 is supported by a cathode support 15 fixed to the outer circumferential portion of the converging electrode 11.

Note that, in the vacuum enclosure 5, a measurement material 17 and a detector 19 are located on an outer side of the output window 3. With this structure, when X-rays 22 emitted from the output window 3 are irradiated on the measurement material 17, the measurement material 17 excites a fluorescent X-ray 21, and the excited fluorescent X-ray 21 passes through a mechanism such as a slit, a spectroscope crystal or the like to the detector 19, where the substance which constitute the measurement material is analyzed.

Next, the operation and effect of the analytical X-ray tube 1 will be explained.

As shown in FIG. 1, electrons e generated by the cathode filament 13 are accelerated by the voltage of a potential difference between the cathode filament 13 and the anode target 7, and converged by the converging electrode 11. Then, the electrons collide with the anode target 7 to generate the X-rays 22. Most of the X-rays generated by the anode target 7 are irradiated in the direction of the output window 3.

The generated X-rays are irradiated to the measurement material 17 through the output window 3.

On the other hand, as shown in FIG. 2, in the anode target 7, secondary electrons 2e are generated at the same time as the X-rays 22 when the electrons e collide.

The secondary electrons 2e scatter in the direction of the entire circumference of the anode target 7 and collide with a side surface of the distal end portion 9b of the anode support 9, thereby exciting impure radiation 33.

However, the outer diameter La of the distal end portion 9b of the anode support 9 is smaller than the outer diameter L2 of the anode target 7, and therefore the impure radiation 33 heading towards the output window 3 is shielded by the anode target 7. Thus, it is possible to prevent the impure radiation 33 from being output from the output window 3.

Further, in the anode support 9, when the secondary electrons 2e move beyond the step portion 9c and collide with the shoulder portion 9d, a coating layer 14 of the same kind of metal as that of the anode target 7 is formed on the shoulder portion 9d. Therefore, X-rays generated by the collision with the shoulder portion 9d excite genuine X-rays 24. Since the genuine X-rays are excited by the same type of metal as that of the anode target 7, they do not interfere with the analysis.

As to tertiary electrons generated by the collision of the secondary electrons, X-rays excited similarly by the collision with the coating layer 14 of the shoulder portion 9d, become genuine X-rays 24.

According to this embodiment, the anode support 9 has an outer diameter La of the distal end portion 9b, which is smaller than the outer diameter L2 of the anode target 7, and an outer diameter of the shoulder portion (rear side portion) 9d on the rear side of the distal end portion 9b, which is greater than the outer diameter L2 of the anode target 7. Further, the coating layer 14, applied on the outer surface, is formed on the shoulder portion (rear side portion) 9d of the same material as that of the anode target 7. Therefore, the secondary electrons generated by the electrons colliding with the anode target 7 can prevent the impure radiation 33 generated on the distal end portion 9b of the anode support 9 from moving towards the output window 3 by the anode target 7, and the X-rays generated by the secondary electrons colliding with the shoulder portion (rear side portion) 9d are made into genuine X-rays 24 by the coating layer 14. Thus, the impure radiation can be reduced.

Since the coating layer 14 is formed on the shoulder portion 9d of the anode support 9, which has an outer diameter Ld smaller than the diameter L1 of the output window 3 (see FIG. 1), X-rays that are highly likely to be directed to the output window 3 by the collision of the secondary electrons become genuine X-rays excited by the coating layer 14. Thus, the impure radiation can be further reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the anode support 9, when the outer diameter Lf of the proximal portion 9f is smaller than the diameter L1 of the output window 3, the coating layer 14 may be formed on the proximal portion 9f as well.

What is claimed is:

1. An analytical X-ray tube comprising:
a vacuum enclosure comprising an output window formed therein to transmit X-rays;
a disc-shaped anode target provided in the vacuum enclosure so as to oppose the output window;
an anode support that supports the anode target by attaching a tip end thereto;
a converging electrode provided on an outer circumference of the anode target; and
a cathode filament provided on an outer circumference of the converging electrode and emitting electrons to be irradiated on to the anode target,
wherein
the anode support includes a distal end portion an outer diameter of which is smaller than an outer diameter of the anode target, and a rear side portion on a rear side of the distal end portion, an outer diameter of which is greater than the outer diameter of the anode target, and an outer surface of the rear portion is coated with a coating layer of a same material as that of the anode target.

2. The analytical X-ray tube of claim 1, wherein
the coating layer is formed on a portion of the anode support, which has an outer diameter smaller than an outer diameter of the output window.
